(19) United States
(12) Patent Application Publication
(10) Pub. No.: US 2018/0159825 A1
(43) Pub. Date: Jun. 7, 2018

(54) NETWORK HOST PROVIDED SECURITY SYSTEM FOR LOCAL NETWORKS

(71) Applicant: CHECK POINT SOFTWARE TECHNOLOGIES LTD., Tel Aviv (IL)

(72) Inventors: Eytan Segal, Kadima (IL); Assaf Harel, Ramat Hasharon (IL)

(21) Appl. No.: 15/820,540

(22) Filed: Nov. 22, 2017

Related U.S. Application Data
(63) Continuation of application No. 13/941,500, filed on Jul. 14, 2013, now abandoned.

(51) Int. Cl. H04L 29/06

(52) U.S. Cl. CPC H04L 63/0227; H04L 63/20; H04L 63/0245

(57) ABSTRACT

A gateway host connected to a network can be programmed to control packet traffic from other hosts on the network. The gateway host sends spoof packets to one or more of the other hosts, rendering them as controlled hosts. Each controlled host, having received the spoof packets, sends network packets for an intended destination, which are intercepted by the gateway host. The spoof packets have caused reconfiguration of the packet routing by the controlled host, such that network packets are rerouted upon their being sent from the controlled host. The gateway host renders a decision on the network packet traffic.

### CROSS REFERENCES TO RELATED APPLICATIONS

This patent application is a continuation patent application of commonly owned U.S. patent application Ser. No. 13/941,500, entitled: Network Host Provided Security System for Local Networks, filed on Jul. 14, 2013, now _______, the disclosure of the aforementioned patent application is incorporated by reference in its entirety herein.

### TECHNICAL FIELD

The present invention is directed to security systems, and in particular to security systems for home or other local area networks (LANs).

### BACKGROUND

As computer use continues to grow, so do home and other local area networks (LANs). As shown in FIG. 1, a home, local, or private network 10 (collectively referred to as a “local network”), as shown in a broken line box, typically includes a router 12, either wired or wireless, and multiple hosts 14, that connect to one or more networks, such as wide area networks, including public networks, such as the Internet 16, via the routers 12. Various servers 17a-17n (“n” being the last server in a series of servers) link to the Internet 16. Packet flow from the hosts 14 to the Internet 16 is shown by the arrows 18. Examples of common network hosts, typically associated with these local networks, include, for example, desktop, laptop and tablet computers, smartphones, set-top boxes, smart televisions, video game consoles, c-book readers, media streaming devices, MP3 players, and other computerized devices.

These hosts 14 are typically not monitored and/or their activity is not controlled by the administrator of the home or local network. As a result, hosts 14 may access content from the Internet 16, which is not suitable, inappropriate, or malicious.

### SUMMARY

The present invention allows the owner or administrator of a home, local or local area network (LAN) or private network (collectively referred to as a “local network”), to perform security functions, including monitoring and/or controlling the activity of the hosts that connect to the local network. The present invention provides the ability to provide security functions such as limiting the access of children or other users to inappropriate content on the Internet, preventing connected hosts from accessing phishing or other malicious web sites, permitting only specific hosts to connect to the local network, protecting hosts that are connected to the local network are protected from malware propagating through the local network and from the Internet, preventing hosts connected to the local network from performing potentially illegal activity such as sharing copyrighted files or hacking web sites on the Internet, preventing hosts that are infected by Botnets from connecting to the home or local network are prevented from their command and control server, or from generating e-mail spam, denial of service, or other network attacks, enforcing bandwidth restrictions for each connected host, requiring payment for hosts in order to connect to the local network, monitoring the network activity of each connected host, and serving as a firewall for traffic to and from hosts connected to the network, for example, blocking incoming connections, stateful inspection of connections, applying a granular firewall rule-base.

The aforementioned security functions performed by the present invention, are performed by a gateway host, which, throughout this document, is the host performing the network security function. The gateway host is, for example, a desktop personal computer, laptop computer, computer-device, or the like, which is connected to the local network either wired or wirelessly. The present invention and its performance do not require any configuration or wiring changes to the network, the router, or other hosts on the network. These other hosts on the local network, e.g., connected to the local network, which are not the gateway host, are termed herein “controlled hosts,” which, throughout this document, are any hosts on the local network for which traffic, e.g., packet traffic, is being controlled by the gateway host.

The present invention performs the aforementioned security functions, as the gateway host, which has become a “man in the middle,” between a controlled host, representative of multiple controlled hosts on the local network, and the router, sends crafted Address Resolution Protocol (ARP) packets to controlled hosts, by ARP spoofing. In ARP spoofing, spoofed or fake packets are sent to the controlled host, causing any traffic, e.g., packet traffic, meant for the Internet Protocol (IP) address of the controlled host, typically via the router, to be sent to the attacker or sender of the ARP Spoof packets, here, the gateway host, which is the “man in the middle.” This ARP spoofing causes the controlled hosts to send all of their network packets, which are intended to be routed via the router to the gateway host, which functions as a “man in the middle.” Similarly, the gateway host may send ARP spoof packets to the router, associating the IP address of a controlled host with the Media Access Control (MAC) address of the gateway host and causing packets being sent from the router to controlled hosts, to be directed to the gateway host. The gateway host may also send ARP spoof packets to a controlled host, associating the IP address of a different host on the local network with the MAC address of the gateway host. This causes packets sent from the controlled hosts, intended for other destinations, either on the local network or another network, such as the Internet, to be directed to the gateway host. The gateway host inspects the received network packets and performs one or more functions on these network packets, such as, forwarding packets, dropping packets, proxy Transport Control Protocol (TCP) connections, terminate TCP connections, redirect Hypertext Transport Protocol (HTTP) requests or any other network manipulation based on need.

In an embodiment of the invention, the gateway host, connected to a network, can be programmed to control packet traffic from other hosts on the network. The gateway host sends spoof packets to one or more of the other hosts, rendering them as controlled hosts. Each controlled host, having received the spoof packets, sends network packets for an intended destination, which are intercepted by the gateway host. The spoof packets have caused reconfiguration of the packet routing by the controlled host, such that network packets are rerouted upon their being sent from the controlled host. The gateway host renders a decision on the packet traffic, for example, a security decision, by inspecting the intercepted network packets in accordance with security rules and policies.

Another embodiment is directed to a computer-program, including a set of instructions stored on non-transitory computer readable media, that when executed by a processor of a computer, the computer linked to a network, cause the computer to perform a method for rendering a decision on the network packets, for example, a security decision. The method comprises: sending at least one spoof packet to at least one host over the network (e.g., a local network, including a local area network (LAN)), the at least one spoof packet causing network packet rerouting over the network, such that network packets released onto the network by the at least one host flow in accordance with the network packet rerouting; intercepting the network packets released by the at least one host; and, rendering a decision on the network packets.

Another embodiment is directed to a computer implemented method for rendering a determination for network packets, which flow over a network (e.g., a local network, a local area network (LAN), or the like). The method comprises: sending, by a computer linked to the network, at least one spoof packet to at least one host over the network, the at least one spoof packet causing network packet rerouting over the network, such that network packets released onto the network by the at least one host flow in accordance with the network packet rerouting; intercepting, by the computer, the network packets released by the at least one host; and, rendering, by the computer, a decision, such as a security decision, on the network packets.

Another embodiment is directed to an apparatus for electronic communication with a computer linked to a network, the apparatus for causing the computer to render a determination on packets. The apparatus comprises: a storage medium for storing computer components; and, a processor in communication with the storage medium for executing the computer components. The computer components comprise: a first component for causing the computer to send at least one spoof packet to at least one host over the network, the at least one spoof packet causing network packet rerouting over the network, such that network packets released onto the network by the at least one host flow in accordance with the network packet rerouting; a second component for causing the computer to intercept the network packets released by the at least one host; and, a third component for causing the computer to render a decision on the network packets. The third component is also for inspecting the network packets, and causes the computer to apply at least one of rules and policies to the network packets. The computer components additionally comprise: a fourth component for causing the computer to act on the packets in accordance with the rendered decision, and a fifth component for causing the computer to forward the network packets acceptable by the rendered decision to their intended destination, over the network.

Another embodiment is directed to an apparatus for linking to a network and rendering a determination on received packets. The apparatus comprises: a generator configured for sending at least one spoof packet to at least one host over the network, the at least one spoof packet causing network packet rerouting over the network, such that network packets released onto the network by the at least one host flow in accordance with the network packet rerouting; a receiver for receiving the network packets released by the at least one host; and, a decision system in communication with the receiver for rendering a determination on the network packets by inspecting the network packets.

Another embodiment is directed to a method for rendering a decision on network packets. The method comprises: providing a computer-program for loading onto a computer to render the computer as a gateway host on a network (e.g., a local network), the computer program including a set of instructions stored on non-transitory computer readable media, that when executed by a processor of the computer, the computer (gateway host) linked to a network or networks (including both local networks, such as local area networks (LANs), private networks, and home networks, and wide area or public networks, such as the Internet), causes the computer to perform a method for rendering a decision on the network packets. The method comprises: sending at least one spoof packet to at least one host over the network, the at least one spoof packet 1) rendering the at least one host as at least one controlled host; and, 2) causing network packet rerouting over the network, such that network packets released onto the network by the at least one controlled host flow in accordance with the network packet rerouting; intercepting the network packets released by the at least one controlled host; and, rendering a decision on the network packets.

### BRIEF DESCRIPTION OF THE DRAWINGS

Attention is now directed to the drawings, where like reference numerals or characters indicate corresponding or like components. In the drawings:

FIG. 1 is a diagram of packet flow in a contemporary local network for its connection to the Internet;

FIG. 2 is a diagram of packet flow in a local network in accordance with the present invention;

FIG. 3 is a diagram of the software components for a network host in accordance with the present invention, as either embodied in media or downloadable over a network;

FIG. 4 is a flow diagram of an exemplary process in accordance with the present invention.

FIG. 5A is a flow diagram of block 102 of the flow diagram of FIG. 4;

FIGS. 5B-1 is a diagram of the original Address Resolution Protocol (ARP) Table of an example controlled host, as per the flow diagram of FIG. 4;

FIG. 5B-2 is a diagram of a rewritten ARP Table of the example controlled host, as per the diagram of FIG. 4;

FIG. 5C is a flow diagram of block 104 of the flow diagram of FIG. 4;

FIG. 5D is a flow diagram of block 114 of the flow diagram of FIG. 4;

FIGS. 6A and 6B show screen-shots which would appear on the monitor of a user associated with a controlled host in accordance with the present invention;

FIG. 7 is a diagram of packet flow in a local network in accordance with an alternative embodiment of the present invention; and,

FIG. 8 is a perspective view of the appliance of the embodiment of FIG. 7.

### DETAILED DESCRIPTION OF THE DRAWINGS

FIG. 2 shows packet flow in a home network, local network, local area network (LAN), or other is private network 20 (collectively referred to hereinafter as a “local network”), for example, as shown in a broken line box, in accordance with the present invention. The local network 20 includes a router 22, representative of all routers on the local network 20, and is similar to the router 12 detailed above, a controlled host 24 and a gateway host 30. The router 22, controlled host 24 and gateway host 30, are exemplary nodes on the local network 20.

The router can be any Internet Protocol (IP) router. It can have a wireless capability supporting any wireless protocol standard, wired Local Area Network (LAN) capability, or both. If there are LAN Ethernet ports, they may be supported by a power over Ethernet standard, allowing connected devices to draw power over the wired Ethernet connection.

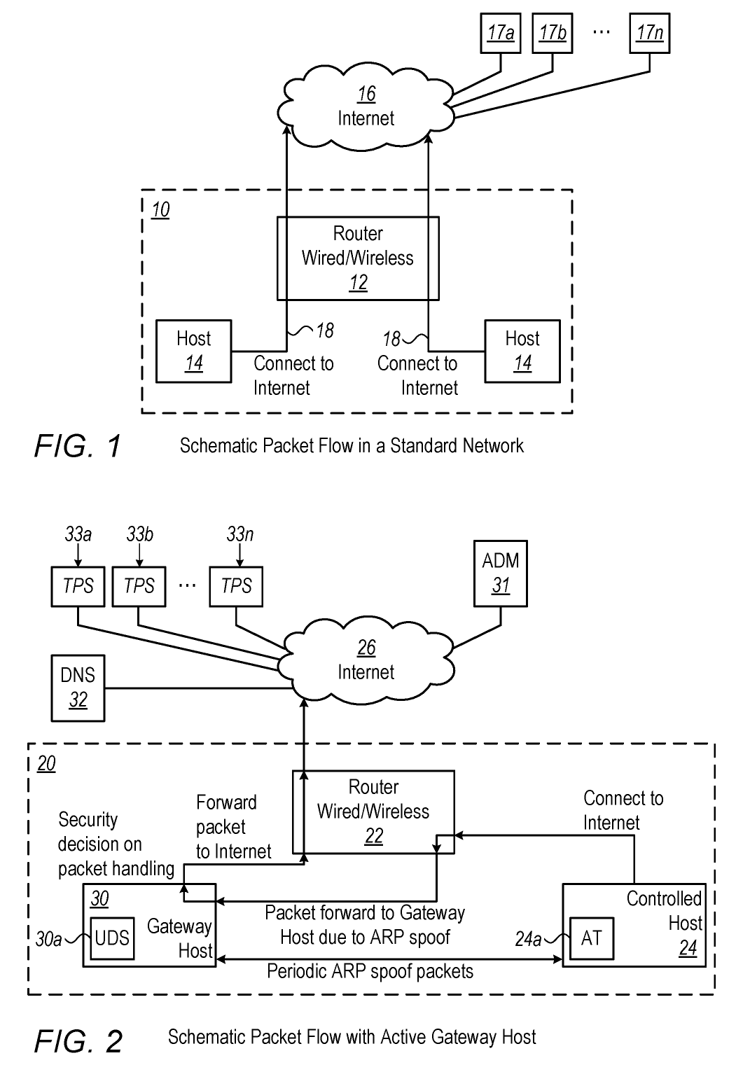

The controlled host 24 is, for example, any Internet Protocol (IP) enabled device whose network traffic is routed through a gateway host, for example, gateway host 30. The controlled host 24 is the same or similar to the hosts 14 detailed above for FIG. 1, and is representative of all controlled hosts on the local network 20. The network traffic of the controlled host 24 is routed through a gateway host 30 (representative of all gateway hosts on the local network 20). The controlled host 24 operating system or network subsystem includes an Address Resolution Protocol (ARP) Table (AT) 24a (FIGS. 5B-1 and 5B-2), and connects to the Internet 26 or other wide area or public network through the router 22 and the gateway host 30.

The gateway host 30, also known as a master host, provides access, full or partial for the controlled host 24 to the Internet 26, by processing the packet traffic from the controlled host 24 in accordance with the processes detailed herein. The gateway host 30, is the host performing the network security function, for example, for the local network 20 as shown. The gateway host 30 is, for example, a desktop Personal computer, laptop computer, computer-device, or the like, which is connected to the local network either wired or wirelessly. The gateway host 30 also includes a web server (WS) 30a, which provides a configuration interface allowing for the administration of the gateway host 30 functionality. In addition the web server component interacts with users on controlled hosts as needed, for example, when access to a specific web site is blocked, and on demand interaction, which is typically performed by intercepting an HTTP (Hypertext Transport Protocol) request initiated by a browser on the controlled host, and redirecting the browser to the captive portal based on the web server (WS) 30a. The web server (WS) 30a, will reside on the network host IP address, for example, http//gatewayhost.home.

An administrative web server 31, with the example address “download.example.com,” a Domain Name Server (DNS) of the Internet Service Provider (ISP) 32, and Third Party Servers (TPS) 33a-33n (“n” being the last server in a series of servers)) link, either directly or indirectly, to the Internet 26. These servers 31, 32, 33a-33n, may be single or multiple servers, and are representative of the multitudes of servers and other components linked both directly and indirectly, wired or wirelessly, to the Internet 26. Two exemplary servers on the network, are third party servers (TPS) 33a-33n, which host web sites-server 33a hosts vacations.example.com, an allowable web site, for example purposes here, while server 33b hosts gambling.example.com, a prohibited web site, for example purposes here.

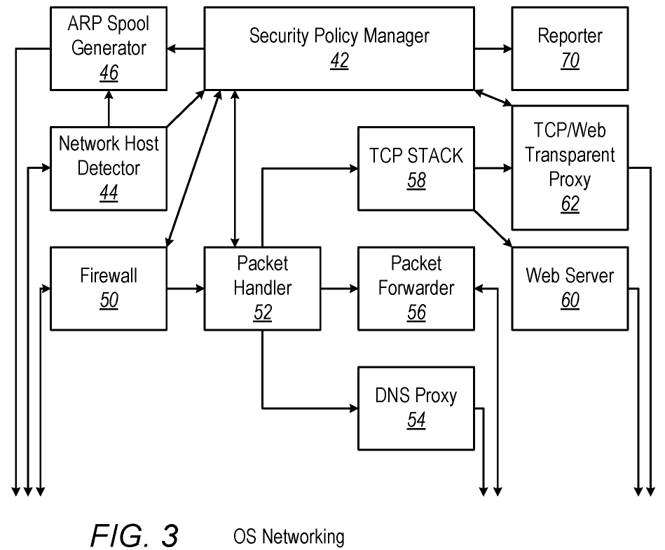

The gateway host 30 includes a computer, such as a PC (Personal Computer), laptop, tablet, computer device, server, smartphone, hardware device or other computer-type device, with processors, memory (e.g., temporary and permanent, volatile and non-volatile), storage and other conventional computer components, such as in a hard disc of the computer, which are programmable with the software, and its components, as shown in FIG. 3 and can execute the software and the methods described therewith.

Adding the gateway host 30 to the local network 20 typically does not require any configuration or wiring changes to the local network 20, the router 22, or other hosts, such as the controlled host 24, on the local network 20. The software components, shown in FIG. 3, function to make the gateway host 30, for example, send ARP spoof packets, receive network packets from the controlled host 24, inspect the network packets from the controlled host 24 in accordance with the rules and policies, and render a security decision for the packets, and based on the security decision, control the flow of the network packets within and out of the local network 20, and the Internet 26.

FIG. 3 details a schematic diagram of software components of a software package, including a computer program in software, which an end user would use to program a host computer on his local network, e.g., local network 20, to render this host computer as the gateway host 30 for the local network 20. The software, including the components shown in FIG. 3, are embodied, in non-transitory computer readable storage media with enabled computer-readable code, for example, in media, such as DVDs (Digital Versatile Discs), CDs (Compact Discs), thumb drives, flash drives or other magnetic or electrical storage media, or are downloadable, for example, from servers (including memory, databases and other non-transitory forms of storage media). These software components are, for example, embedded in media, or downloadable over a network(s).

An exemplary server which stores the software, and from which a download can be made, upon a user (who controls the gateway host 30) accessing the server, is the administrative web server 31. The software download from the administrative web server 31 is over a network, such as the Internet 26. The installation and activation of the aforementioned software package maps back to a designated web server, such as administrative web server 31, and, for example, requires the user (associated with the gateway host 30) to activate the loaded or downloaded software at this designated web site/server 31. This activation renders the gateway host 30 (which stores the software code in its main non-volatile memory, such as its hard disk) operational as such. All of the aforementioned components of the software are linked together, whereby any component is linked to any other component, either directly and/or indirectly.

Central to the components of the software for the gateway host 30 is the security policy manager 42. This security policy manager 42 provides controls and applies various rules and policies to the network packets from the controlled host 24, hence, performing the inspection of the network packets, and ultimately, rendering a security decision on these packets.

The security policy manager 42 is linked to the network host detector 44, and the ARP spoof generator 46. The ARP Spoof generator 46 is also linked to the security policy manager 42.

The network host detector 44 detects the controlled hosts 24 on the network 20. Detection of the controlled hosts 24 as they connect to the local network 20, is performed by the network host detector 44. The host detector 44 uses an ARP Protocol to send ARP Packets to every possible IP address on the local network 20, and determine if any ARP responses, e.g., packets, from the controlled hosts 24, with their IP addresses, have been returned to the network host detector 44. This information as to the controlled hosts 24 detected on the local network 20, from ARP packets is sent to the security policy manager 42 and the ARP spoof generator 46.

The ARP spoof generator 46, in accordance with rules and policies of the security policy manager 42, sends ARP poisoned packets, or “spoof packets,” to each controlled host 24, in accordance with rules and policies of the security policy manager 42. The “spoof packets” are detected by the network host detector 44.

These “spoof packets,” referred to herein, are, for example, standard ARP protocol reply packets, as defined in, for example, Network Working Group, Request for Comments: 826, An Ethernet Address Resolution Protocol, David C. Plummer, November 1982 (RFC 826), and all updates, modifications and revisions thereof. RFC 826 is incorporated by reference herein. The aforementioned spoof packets are either sent or broadcast to all hosts, e.g., all controlled hosts 24, on the local network 20, or unicasted to a specific host, e.g., a specific controlled host 24, on the local network 20. An ARP protocol reply packet is sent periodically by the gateway host 30 on the local network 20. The gateway host 30, typically sends the reply packets periodically to ensure the preservation of the desired ARP table entries in the target hosts, e.g., controlled hosts 24.

In an ARP Spoof Packet sent by the gateway host 30, the sender Media Access Control (MAC) address field is set to be the authentic or true MAC address of the gateway host 30. As shown in FIGS. 5B-1 and 5B-2, to which attention is now directed, the Sender IP Address field is forged to be that of a different host on the network (different from the IP address of the sending host), typically that of the router 22 (box 300 in the ARP Tables (AT) 24a for the controlled host 24. This spoofing or forging of the Sender IP Address field causes recipient host(s) to associate, in their ARP table (e.g., ARP Table (AT) 24a), the sending host's MAC address (i.e., the gateway host 30 MAC address of box 302 of the ARP Tables 24a) with the target IP address (e.g., the IP address of the router 22, box 304 of the. ARP Tables 24a), which belongs to a different host. It should be further noted that ARP spoof packets may be sent by the gateway host to any node on the local network subnet in order to manipulate its ARP table thus redirecting packets to the gateway host. For example, ARP spoof packets may be sent to a controlled host 24 associating the IP address of the router 22 with the MAC address of the gateway host 30, ARP spoof packets may be sent to the router 22 associating the IP address of the controlled host 24 with the MAC address of the gateway host 30, and ARP spoof packets may be sent to a controlled host 24 associating the IP address of a different host on the local network 20 with the with the MAC address of the gateway host 30.

These spoof packets, once received in the controlled host 24, cause a rewrite of the ARP Table 24a of the controlled host 24, to rewrite the entry within the controlled host 30 ARP table 30b that contains the association between the router 22 IP address and it's MAC address to associate the router 22 IP address with the gateway host 30 MAC address, This rewrite renders the gateway host 30, as a “man in the middle,” between the controlled host 24 and the router 22. As a result, IP packets sent by the controlled host 24 intended for the router 22, will be initially sent (rerouted) at the Ethernet level to the gateway host 30, giving the gateway host 30 full control of network traffic, to and from the controlled hosts 24. Additionally, the aforementioned ARP positioned packets or “spoof packets,” are typically sent periodically, such as at intervals, for example, approximately two seconds apart. However, other intervals, as well as random sendings, are also sufficient.

A firewall 50 links to the security policy manager 32. The intercepted network packets from the requisite controlled hosts 24 are received in the gateway host 30, at the firewall 50. The firewall 50 is, for example, a default, allowing packets which enter to be forwarded. The firewall 50 functions as a first filter in accordance with the rules and policies of the security policy manager 42. The firewall 50 is programmed to block and/or drop, and otherwise filter packets, which enter the gateway host 30, from each controlled host 24, for which the gateway host 30 has become the “man in the middle.” By “filter” in this document, it is meant, for example, forwarding packets, blocking packets, dropping packets, performing deep packet inspection, stateful inspection, performance network address translation, or any other network manipulation based on need. This includes the firewall 50 having the ability to block or drop network packets, which it receives (outbound) from the requisite controlled host 24. The firewall 50 also acts similarly on packets it receives (inbound) from over the local network 20.

A packet handler 52 is linked to the firewall 50 and to the security policy manager 42. The packet handler 52 determines whether packets need to be redirected (sent to the DNS (Domain. Name Server) proxy 54), forwarded (sent to the packet forwarder 56), or further inspected (sent to the TCP (Transmission Control Protocol) stack 58), for example, at a higher protocol level. The packet handler 52, typically inspects the packets received from the firewall 50 at the IP (Internet Protocol) or (L3) level 3 of the TCP/IP (Transmission Control Protocol/Internet Protocol) protocol (RFC 826).

While the packet handler 52 is shown as a separate component from the firewall 50, the packet handler 52 can be integrated with the firewall 50 as a single component. Moreover, the firewall 50 and packet handler 52, either separate or integrated, are optionally operated by the operating system of the gateway host 30.

The DNS Proxy 54 serves to intercept received DNS packets (also known as DNS requests), which were sent from the requisite controlled host 24 and intended for the router 22. The DNS Proxy 54 controls the flow of DNS packets, to give the gateway host 30 full control over DNS packets and responses thereto for each controlled host, from which it intercepts the DNS packets. The DNS proxy 54 will either forward the intercepted DNS packets to an external DNS server, such as the server 32, or will generate its own reply. This reply may be either: 1) blocking access based on DNS host names, by changing resolved DNS responses, or, 2) resolve specific names, e.g., for identifying the gateway host 30.

The packet forwarder 56 receives packets from the packet handler 52 and forwards these packets to their intended or designated IP Address. For example, packets are forwarded to the router 22 and on to the intended destination (IP address) for the packets. The packet forwarder 56 is optionally operated by the operating system of the gateway host 30. A packet received by the gateway host 30 is forwarded by modifying the received Ethernet frame with a source MAC address to the gateway host 30 MAC address and the destination MAC address to that of the router 22.

The TCP (Transmission Control Protocol) stack 58 is linked to the packet handler 52 and the security policy manager 42. The TCP stack 58 receives packets from the packet forwarder 52, which must be examined at the TCP level or level 4 (L4) of one or more of the protocols, as defined in, for example, 1) Network Working Group, Request for Comments: 675, Specification of Internet Transmission Control Program, Vinton Cerf, et al., December 1974 (RFC 675); 2) Internet Protocol, DARPA Internet Program Protocol Specification, Request For Comments 791, September 1981 (RFC 791); 3) Request for Comments 793, Transmission Control Protocol, DARPA Internet Program Protocol Specification, September 1981 (RFC 793); 4) Network Working Group, Request for Comments 1122, Requirements for Internet Hosts—Communication Layers, Internet Engineering Task Force, R. Braden, October 1989 (RFC 1122), 5) Network Working Group, Request for Comments: 2460, Internet Protocol, Version 6 (IPv6), S. Deering, et al., September 1998 (RFC 2460); and, 6) Network Working Group, Request for Comments: 5681, TCP Congestion Control, M. Allman, et al., September 2009 (RFC 5681), and all updates, modifications, and revisions thereof. RFC 675, RFC 791, RFC 793, RFC 1122, RFC 2460 and RFC 5681 are all incorporated by reference herein. The TCP stack 58 inspects the TCP data stream for threats or other rules and policy violations, and can accordingly, terminate and generate standard connections. For example, in accordance with an application of the rules and policies from the security policy manager 42, the TCP stack 58 can forward packets to the web server component 60 or the TCP/Web Transparent proxy component 62, by making a Network Address Transition (NAT) operation on the packets, altering the destination TCP Port to either that of the web server component 60 or the TCP Proxy component 62. The TCP stack 58 is optionally operated by the operating system of the gateway host 30.

The web server component 60 is linked to the TCP stack 58. The web server component 60 serves web pages that are hosted on the gateway host 30. These web pages include, for example, web page WP 30a (http://gatewayhost.home), which may be an access block web page, and software management web interfaces (gateway host 30 management web interface).

The TCP/Web Transparent Proxy 62 is linked to the TCP stack 58 and the security policy manager 42. The TCP/Web Transparent Proxy 62 operates on the packets, forwarded from the TCP Terminator stack 58 at the TCP protocol level (L4) (RFC 675, RFC 791, RFC 793, RFC 1122, RFC 2460 and RFC 5681). This component 62 proxies data between two peers, and will, in accordance with the rules and policies of the security policy manager 42, for example: 1) proxy connections to their intended IP Address, typically through the router 22; 2) filter and alter the packets, e.g., removing malicious links in the packets; or, 3) blocking and rewriting the packets, and redirecting web requests.

A reporter component 70 is linked to the Security policy manager 42. This reporter component 70 functions to generate reports on network activity and security incidents, report analytics, etc. The reporter component 70 can also write logs of all activity taken by the gateway host 30, and can generate reports for users. The reporter component 70 can also send timely reports (e.g., daily, weekly, monthly) to users, as well as send short messages, push notifications (e.g., to a smartphone application using push notification services provided by a mobile or other operating system), e-mail or Short Message System (SMS) messages of incidents, such as viruses on the network 20.

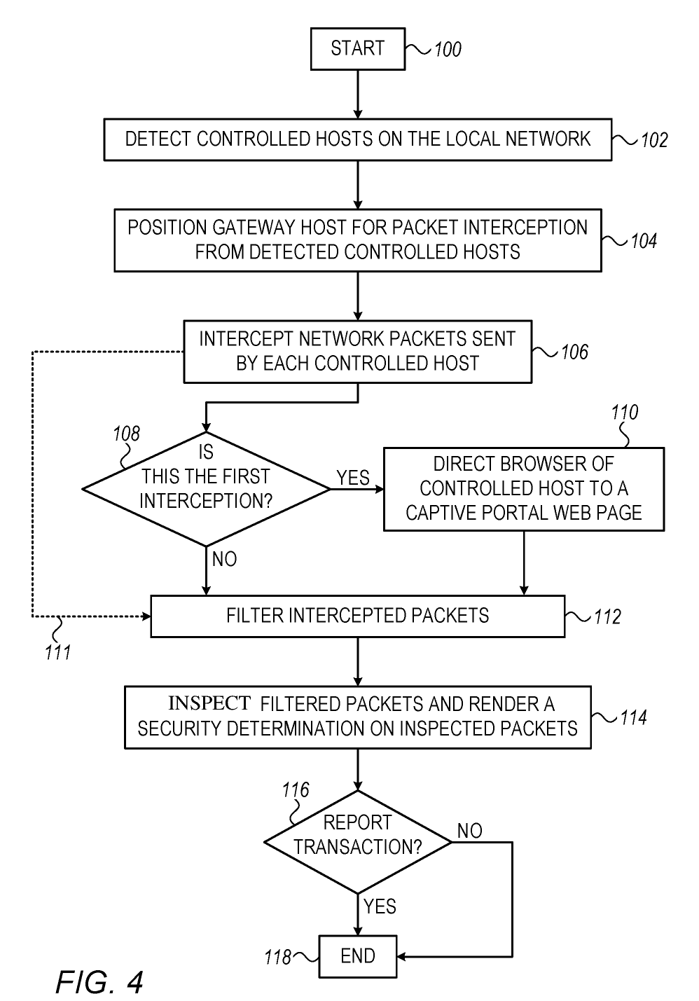

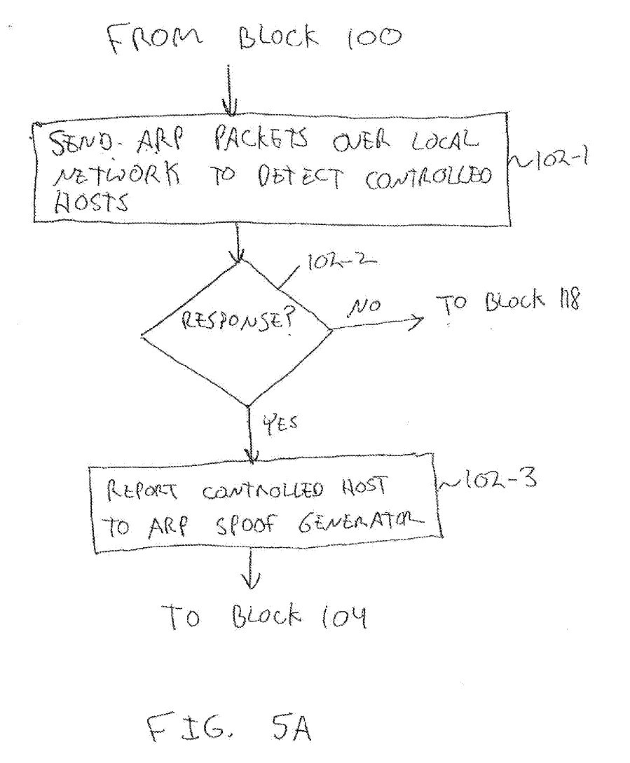

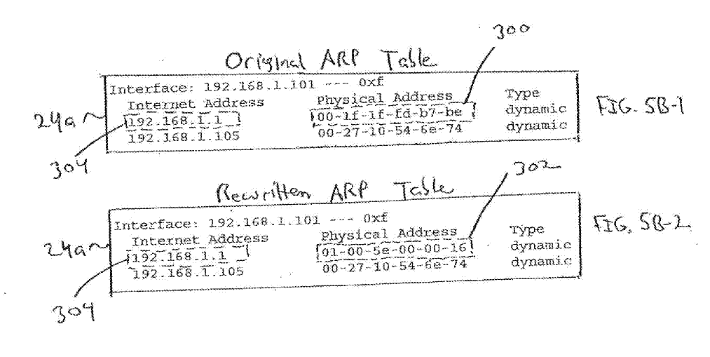

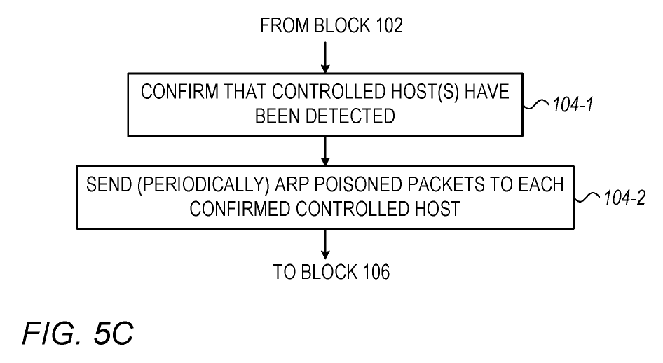

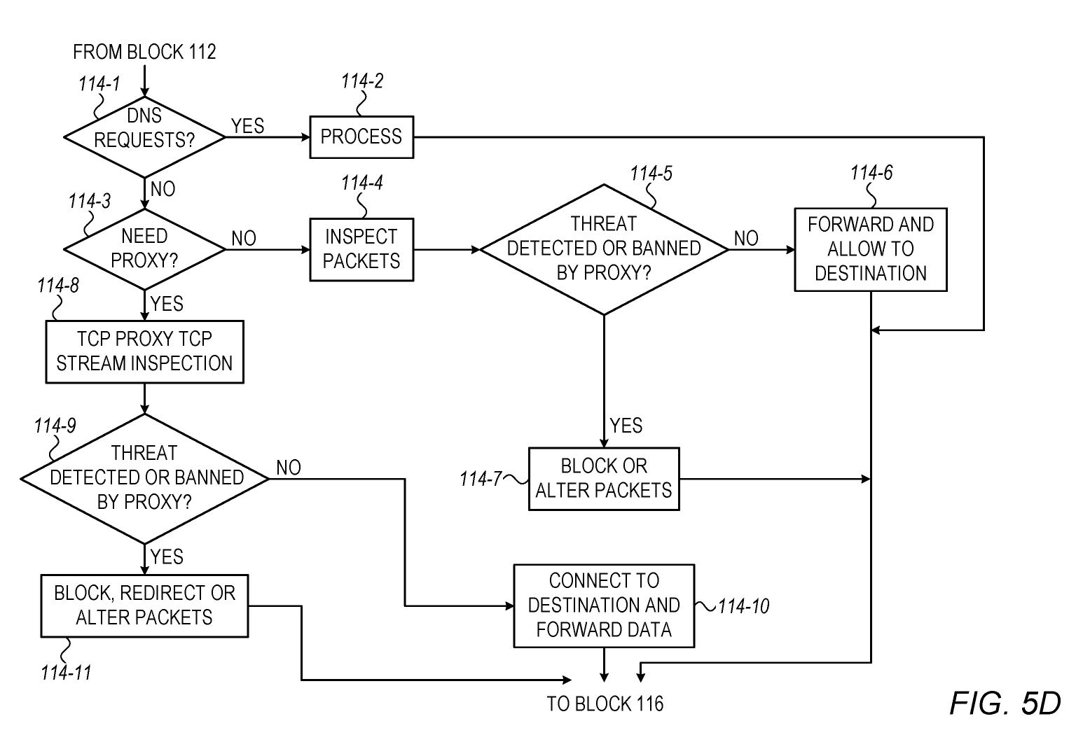

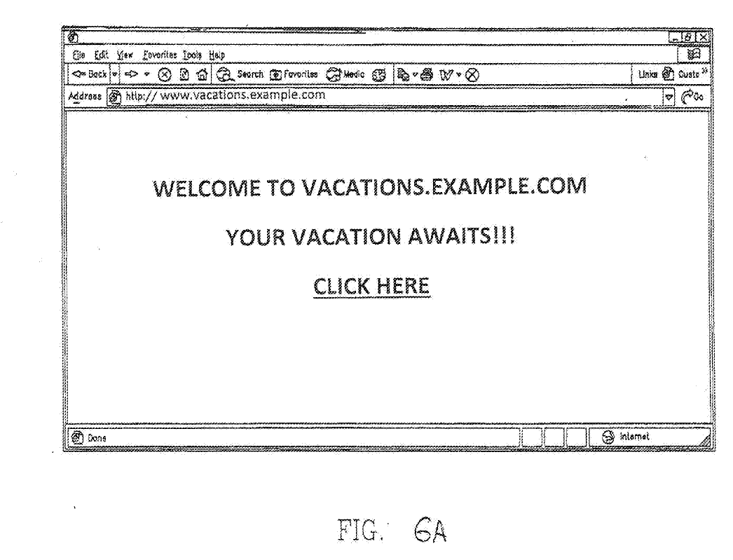

FIG. 4 is a flow diagram detailing an exemplary process of the present invention. The exemplary process of FIG. 4, and the exemplary sub-processes of FIG. 4, shown in FIGS. 5A, 5C and 5D, and detailed below, are, for example, performed in real time and automatically, except where indicated.

In FIG. 4, the process starts at block 100, and moves to block 102. At block 102, a network host, e.g., a controlled host, such as controlled host 24, is detected by the Network Host Detector 56, of the gateway host 30, by one of several conventional methods. This detection may be, for example, periodic, at various intervals, but may also be random.

Turning to FIG. 5A, block 102 is shown in subprocesses. For example, at block 102-1, ARP packets are sent over the local network 20 to detect controlled hosts, such as controlled host 24 (FIG. 2). It is then determined if responses are received from controlled hosts at the network host detector 44, at block 102-2. If responses are not received, the process moves to block 118, where reporting may occur, and then to block 120, where the process ends.

Returning back to block 102-2, if responses are received, the process moves to block 102-3, where controlled hosts are reported to the ARP Spoof Generator 44. The process then moves to block 104.

At block 104, the gateway host 30 obtains the MAC address of the controlled host 24, and the router 22. The gateway host 30 causes a rewrite of the ARP Table (AT) 24a in the controlled host 24, such that the MAC Address of the router 22 (shown in broken line box 300 of FIG. 58-1, the ARP Table 24a of the controlled host 24, as originally established, prior to being rewritten) is replaced with the MAC address of the gateway host 30 (shown in broken line box 302 of FIG. 5B-2, the ARP Table 24a of the controlled host 24 after it has been rewritten). The IP address of the router 22 or target is shown in box 304 of the ARP Tables 24a. This rewrite of the ARP Table establishes the gateway host 30 as a “man in the middle.” This positioning of the gateway host as “the man in the middle” is such that the MAC address of the gateway host 30 is associated with the with the IP address of the router 22, the target host, so that any traffic meant for the router 22 or target host, such as packet traffic from the controlled host 24, will be sent to the gateway host's 30 MAC address (where, for example, the gateway host 30 could be programmed to: 1) inspect the packets, and forward the traffic to the actual default gateway, such as the router 22; 2) modify the data before forwarding it; 3) drop packets, or 4) block packets from being forwarded, and respond with spoof packets-for example, terminate TCP connections intended for the Internet 26 while spoofing the controlled host's 24 Internet Protocol, and provide a response in accordance with the rules and policies from the security policy manager 42).

Turning to FIG. 5C, the process of block 104 is shown as subprocesses. For example, at block 104-1, the network host detector 44 confirms that a controlled host, such as controlled host 24, has been detected, based on rules and policies received from the security policy manager 42. With the controlled host 24 determined to be a controlled host, and confirmed as such, the MAC.

Address for the controlled host 24, is reported to the security policy manager 42, which then signals the ARP spoof generator 44 to send spoof packets (also known as ARP Poisoned packets) to the reported or reporting and typically confirmed controlled host 24, at block 104-2. This sending is typically periodic, but can also be random. These ARP poisoned packets cause the aforementioned rewriting of the ARP Table (AT) 24a of the requisite controlled host 24. Use of the ARP spoof packets mimics an “attack” on the controlled host 24, and causes the controlled host 24 to send its network packets, including, for example, Ethernet packets, to the router 22, via the gateway host 30, where the packets are “intercepted,” as the process moves to block 106.

At block 108, where the process has moved from block 106, it is determined if this interception is the first interception for the specific controlled host, such as controlled host 24. If yes, the process moves to block 110, where the browsing is directed to a captive portal web page which, for example, displays a message that network activity from this controlled host is being monitored and controlled. The web page, for example, will display the above-provided details of the name of the user, e-mail, and/or telephone number. The web page may be hosted, for example, at embedded web server (WS) 30a on the gateway host 30, or an associated server. The process then moves to block 112.

Returning to block 108, where the process has moved from block 106, it is determined that the interception is not the first interception, the process moves directly to block 112.

Alternately, the processes of blocks 108 and 110 may be bypassed altogether if desired, as these processes are optional. This bypass is as shown by the broken line arrow 111. For example, this is the case with the device 400 detailed below.

At block 112, the gateway host 30 filters the intercepted packets. The filtering is by the firewall 50, in accordance with rules and policies from the security policy manager 42. The filtering in accordance with the rules and policies includes forwarding packets, blocking packets, dropping packets, performing deep packet inspection, stateful inspection, performance network address translation, or any other network manipulation based on need.

The forwarded packets and any other packets which pass through the filtering by the firewall 50, based on the aforementioned rules and policies, are then inspected and a security determination is made at block 114. Inspection is performed, for example, by the packet handler 52. The packet handler 52 determines if the packets include DNS packets (with a DNS request), are suitable for forwarding to their intended destination over the Internet 26, must be blocked or altered, or require further inspection at the TCP level. The packet handler 52, and in numerous instances, coupled with the DNS Proxy 54, Packet Forwarder 56, TCP Terminator 58, Web Server Component 60, and TCP/Web Transparent Proxy 62, then render a security determination on the packets, as detailed, for example, in the flow diagram of FIG. 5C.

Attention is also directed to FIG. 5D, which details a flow diagram of exemplary processes for block 114.

At block 114-1 it is determined if the packets are DNS packets (including DNS Requests). If yes, the packets are routed to the DNS Proxy 54 and processed, at block 114-2. At block 114-2, the DNS proxy 54 will process the packets by, for example, either: 1) forwarding the intercepted DNS packets to an external DNS server, such as the DNS server of the ISP (Internet Service Provider) 32, or 2) will generate its own reply. This reply may be, for example, either: 1) blocking access based on DNS host names, by changing resolved DNS responses, or, 2) resolve specific names, e.g., for identifying the gateway host 30. When one of the aforementioned actions is completed, the process moves to block 116.

Returning to block 114-1, if the packets are not DNS Packets with DNS requests at block, the process moves to block 114-3, where it is determined if the packets need to be proxied. If a proxy is not needed, the packets are inspected, in accordance with the rules and policies from the security policy manager component 42, by the packet handler 52, at block 114-4. Applying the rules and policies, the packet handler 52 determines if a threat is detected and/or the packets are banned by the proxy, at block 114-5. If a threat is not detected and there is not a ban from the proxy, the process moves to block 114-6, where the packets are forwarded to their intended destination, by the packet forwarder 56. The process then moves to block 116.

Returning to block 114-5, applying the rules and policies, if the packet handler 52 detects a threat and/or the packets are banned by the proxy, the process moves to block 114-7, where the packets are blocked or altered, for example, by the packet handler 52. With the packets blocked or altered, the process moves to block 116.

Returning to block 114-3, if a proxy is needed, the process moves to block 114-8, where the TCP connections are terminated by the TCP stack 58 and directed to the TCP/Web transparent proxy 62 for inspection of the TCP data stream (for example HTTP request and response) for threats or other rules and policy violations. The process moves to block 114-9, where it is determined if a threat is detected and/or there is a ban from the proxy, as controlled by the TCP stack 58.

At block 114-9, if a threat is not detected and there is not a ban from the proxy, the process moves to block 114-10, where a new TCP connection is made by the proxy to the original destination address of the IP packets and the incoming and outgoing data is relayed by the proxy between the controlled host 24 and the destination web server, for example, one of the third party servers (TPS) 33a-33n, for example, by the TCP/Web Transparent Proxy 62. The process then moves to block 116.

Returning to block 114-9, if a threat is detected and/or there is a ban from the proxy, as controlled by the TCP stack 58, the process moves to block 114-11. At this block, the proxy may choose to block the TCP connection, generate a response to the client (residing on the controlled host 24), for example, generate a HTTP redirect response to the web page 30a of the gateway host 30, or alter either the incoming or outgoing TCP streams while proxying the connection to its original destination, for example, by the TCP/Web Transparent Proxy 62. The process then moves to block 116.

At block 116, the transaction including the packets and the security determination for the packets (from block 114) can be reported. Reporting is performed by the reporter component 70 (FIG. 3). The process then moves to block 118 where it ends.

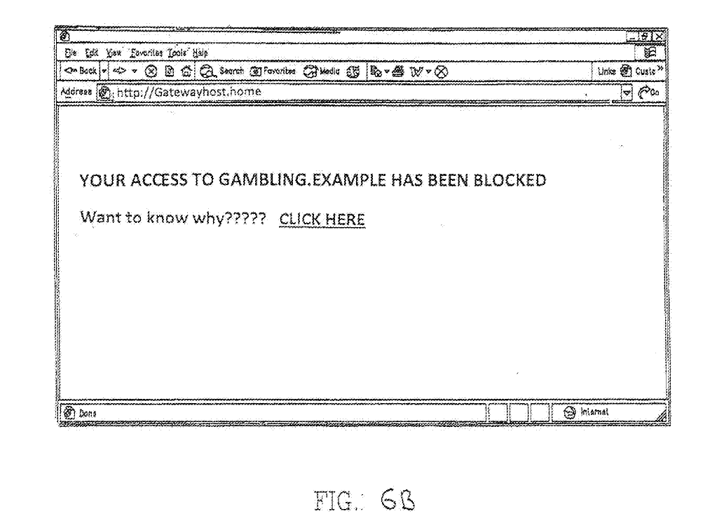

For example, if going from blocks 114-9 to 114-10 to 116 to 118, where the user associated with a controlled host 24 wanted to access the web page vacations.example.com, a non-threat and allowed destination, hosted by third party server (TPS) 33a, the gateway host 30 would allow this access. The resultant screen shot would be, for example, that of FIG. 6A.

For example, if going from blocks 114-9 to 114-11 to 116 to 118, where the user associated with a controlled host 24 wanted to access the web page gambling.example.com, a threat and/or a prohibited destination, hosted by server 33b, the gateway host 30 would block this access. The web page component 60 activates, and the block redirect http://gatewayhost.home associated with the web page 30a of the gateway host 30 appears on the monitor of the user, with an example screen shot, for example, that of FIG. 6B.

Additionally, in order to prevent abuse of the aforementioned system, there are additional processes. For example, when the system of the invention is enabled for a local network, such as the local network 20, the person configuring the system is required to provide information to the administrative web server (ADM) 31, including, for example, their full name and their e-mail address and/or telephone number. An activation code or URL (uniform resource locator) will be sent via e-mail or text message, or other suitable messaging technique. Activation will only be possible after entering the code to the product or browsing to the set link. This provides for the confirmation of the identity of the authorized system person, entity or the like.

Additionally, the person activating the system will be required to acknowledge to the administrative web server (ADM) 31, for example, by enabling a checkbox on a monitor, or a web page, electronic page, or the like, that he is the owner of the network, such as the network 20, or is authorized by the network owner to activate the system on the local network. The details provided for the system (e.g., name, e-mail, telephone number), and the MAC address of the router 22 for the network 20, are stored on a network server, for example, the administrative web server 31. This allows for forensic analysis in case of abuse of the system. Additionally, the administrator of the administrative web server 31 may program the administrative web server 31 with updates for the software components for the gateway host 30, which can be pushed to the gateway host 30, or otherwise downloaded to the gateway host 30 (by the user) over the Internet 26.

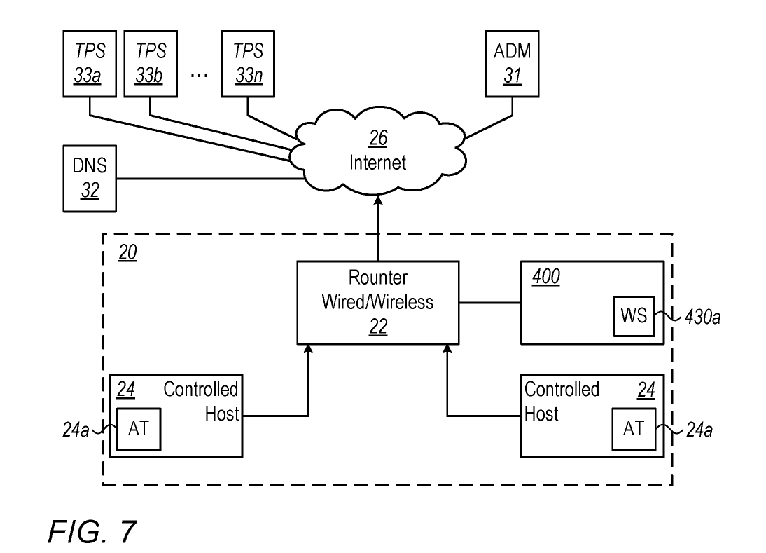

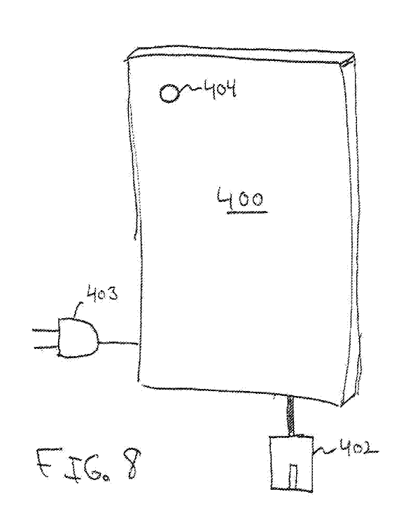

FIGS. 7 and 8 show a device 400 that functions similarly to that of the gateway host 30, as detailed above. The device 400 is, for example, hardware, software or both, corresponding to the software components of FIG. 3, and which performs similarly to the software when employed in the gateway host 30. The device 400 is, for example, a “plug and play” device.

As shown in FIG. 7, the device 400 links directly or indirectly to a LAN network socket of the router 22, on the local network 20. The actual router 22 and device 400 are shown in FIG. 8. The device 400 includes processors, storage media, and other components, logic units, signal processors, transmitters, receivers, and the like, and functions to control the controlled hosts 24 on the local network 20, similar to that of the gateway host 30, as detailed above, with all functions the same or similar, except where indicated. The device 400 includes a web server (WS) 430a similar in all aspects and operations to web server (WS) 30a, including the address http://gatewayhost.home, and is in accordance therewith, as detailed above. Alternatively, the device 400 can be wirelessly linked to the router 22 to perform the functions of the gateway host 30, as detailed above.

The device 400 includes an Ethernet plug 402 (e.g., an RJ45 type plug), an optional power adapter 403 and a light 404 (e.g., a light emitting diode (LED)), to indicate if the device 400 is operational, as shown in FIG. 8. The device 400 operates in accordance with the flow diagrams of FIGS. 4, 5A, 5C and 5D, except that in FIG. 4, the process goes from block 106 to block 112 (via arrow 111).

While the invention above has been described with the process of rendering a security decision on the packets, which are directed into the gateway host, this is exemplary only. Other decisions which are permissible on the packets redirected (and/or intercepted) from the controlled hosts, and which are made by the gateway host in accordance with the description above, and the requisite rules and policies programmed into the security policy manager component, include, for example, decisions on acceleration, caching, content distribution, quality of service (QOS), cloud storage, identity awareness and the like.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including non-transitory magnetic, optical, or semiconductor storage.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. A computer program, including a set of instructions stored on non-transitory computer readable media, that when executed by a processor of a computer, the computer linked to a first network, cause the computer to perform a method for rendering a decision on the network packets, comprising:
sending at least one spoof packet to at least one host over the first network, the at least one spoof packet including at least one Address Resolution Protocol (ARP) spoof packet for rewriting an ARP table associated with the at least one host, and causing network packet rerouting over the first network, such that network packets released onto the first network, by the at least one host, flow in accordance with the network packet rerouting, to access network packet communications of the at least one host; and,
controlling packet flow to a second network, external to the first network, including:
intercepting the network packets released by the at least one host; and,
rendering a decision on the intercepted network packets, at least based on Uniform Resource Locator (URL) filtering, to control the network packet communications from the at least one host, including injecting packets for redirecting a browser of the at least one host from the intended destination to a different destination along either the first network or the second network; and,
acting on the network packets in accordance with the rendered decision.

2. The computer program of claim 1, wherein the method additionally comprises:
forwarding the network packets determined to be acceptable by the rendered decision to their intended destination, to the second network.

3. The computer program of claim 2, wherein the intended destination includes a web site.

4. The computer program of claim 1, wherein the rendering a decision on the network packets is based on inspecting the network packets.

5. The computer program of claim 2, wherein the decision includes a security decision.

6. The computer program of claim 1, wherein the at least one ARP spoof packet includes a plurality of ARP spoof packets.

7. The computer program of claim 1, wherein the acting on the network packets in accordance with the rendered decision, includes filtering the network packets.

8. The computer program of claim 1 being downloadable over the first network and the second network.

9. The computer program of claim 1 stored on a portable non-transitory storage media.

10. The computer program of claim 9, wherein the first network includes a local network, and the second network includes a network external to the first network.

11. The computer program of claim 1, wherein the network packets are Layer 2 Ethernet packets.

12. A computer implemented method for rendering a determination for network packets, which flow over a first network to a second network, comprising:
sending, by a computer linked to the first network, at least one spoof packet to at least one host over the first network, the at least one spoof packet including at least one Address Resolution Protocol (ARP) spoof packet for rewriting an ARP table associated with the at least one host, and causing network packet rerouting over the first network, such that network packets released onto the first network, by the at least one host, flow in accordance with the network packet rerouting, providing the computer with access to the network packet communications of the at least one host; and,
controlling packet flow to a second network, outside of the first network by:
intercepting, by the computer, the network packets released by the at least one host; and,
rendering, by the computer, a decision on the intercepted network packets, at least based on Uniform Resource Locator (URL) filtering, to control the network packet communications from the at least one host, including the computer injecting packets for redirecting a browser of the at least one host from the intended destination to a different destination along either the first or the second network.

13. The computer implemented method of claim 12, wherein inspecting the network packets includes applying at least one of rules and policies for the network packets.

14. An apparatus for electronic communication with a computer linked to a first network, the apparatus for causing the computer to render a determination on packets, the apparatus comprising:
a storage medium for storing computer components; and,
a processor in communication with the storage medium for executing the computer components, the computer components comprising:
a first component for causing the computer to send at least one spoof packet to at least one host over the first network, the at least one spoof packet including at least one Address Resolution Protocol (ARP) spoof packet for rewriting an ARP table associated with the at least one host, and causing network packet rerouting over the first network, such that network packets, released onto the first network by the at least one host, flow in accordance with the network packet rerouting, providing the computer with access to the network packet communications of the at least one host; and,
a second component and a third component for controlling packet flow from the first network to a second network;
the second component for causing the computer to intercept the network packets released by the at least one host; and,
the third component for causing the computer to render a decision on the intercepted network packets, at least based on Uniform Resource locator (URL) filtering, to control the network packet communications from the at least one host, the decision including injecting packets for redirecting a browser of the at least one host from the intended destination to a different destination along either the first or the second network; and,
a fourth component for causing the computer to act on the packets in accordance with the rendered decision.

15. The apparatus of claim 14, additionally comprising a fifth component for causing the computer to forward the network packets, acceptable by the rendered decision to their intended destination, to the second network.

16. The apparatus of claim 14, wherein the third component for inspecting the network packets includes causing the computer to apply at least one of rules and policies to the network packets.

17. An apparatus for linking to a first network and rendering a determination on received packets comprising:
a generator configured for sending at least one spoof packet to at least one host over the first network, the at least one spoof packet including at least one Address Resolution Protocol (ARP) spoof packet for rewriting an ARP table associated with the at least one host, and causing network packet rerouting over the first network, such that network packets released onto the first network by the at least one host flow in accordance with the network packet rerouting, providing access to network packet communications of the at least one host;
a receiver for receiving the network packets released by the at least one host in response to the at least one host receiving the at least one spoof packet; and,
a decision system in communication with the receiver for rendering a determination on the received network packets and controlling the flow of the network packets from the first network to a second network by:
inspecting the network packets; and,
injecting packets for redirecting a browser of the at least one host from the intended destination to a different destination along either the first or the second network.

18. The apparatus of claim 17, wherein the receiver is configured for intercepting the network packets released by the at least one host.
